(19) United States
(12) Patent Application Publication
(10) Pub. No.: US 2012/0267811 A1
(43) Pub. Date: Oct. 25, 2012

(54) METHODS AND APPARATUS FOR THE RAPID MANUFACTURE OF DIRECT CUSTOM MOUTHPIECES

(76) Inventor: Mark E. Weitzman, Ventura, CA (US)

(21) Appl. No.: 13/452,486

(22) Filed: Apr. 20, 2012

Related U.S. Application Data
(60) Provisional application No. 61/477,534, filed on Apr. 20, 2011.

(51) Int. Cl. A61C 9/00; A61C 19/06

(52) U.S. Cl. 264/16; 425/403

(57) ABSTRACT

A method for rapidly creating a custom mouthpiece is disclosed. The method may include providing a form defining a void sized and configured to accommodate teeth of a user. The method may also include applying a curing polymer within the void. The method may also include placing the form and the curing polymer within a mouth of the user so as to move the teeth of the user into the curing polymer to make a mold of the teeth of the user. The method may also include allowing the curing polymer to cure while in the mouth of the user, and removing the form and curing polymer from the mouth of the user.

### BACKGROUND OF THE INVENTION

1. The Field of the Invention

The present invention relates to methods and apparatus for the rapid manufacture custom mouthpieces, such as direct custom whitening dental mouthpieces, direct mouthguards, direct bite guards, and other direct custom dental appliances. This rapid direct manufacture of custom mouthpieces of the claimed invention is in contrast to traditional indirect methods and apparatus for manufacture of custom mouthpieces previously practiced.

2. The Relevant Technology

A mouthguard (also known as a mouth protector, mouth piece or gumshield) is a protective device for the mouth that covers the teeth and gums to prevent and reduce injury to the teeth, arches, lips and gums. Mouthguards are most often used to prevent injury in contact sports, as a treatment for bruxism or TMD, or as part of certain dental procedures, such as tooth bleaching.

Mouthguards can be stock, or ready-made, mouth adapted, such as “boil and bite”, or custom made. Stock, or ready-made mouthguards are manufactured in a preformed shape in various sizes but with nearly no adjustment to fit the user's mouth. The only adjustment possible is minor trimming with a knife or scissors.

Mouth adapted, or “boil and bite”, mouthguards generally include thermo-plastic material manufactured in a pre-formed shape in various sizes that can be adapted to fit more closely to an individual's teeth and gums by heating and molding such as boiling then placing in the mouth. Such mouth adapted guards are usually made of Ethylene-vinyl acetate, which is the copolymer of ethylene and vinyl acetate. The weight percent vinyl acetate usually varies from 10 to 40%, with the remainder being ethylene.

To form a boil and bite mouthguard, a pot is filled with water and heated to a boil. A blank mouthguard is placed in the water for about 30 seconds. The heated blank mouthguard is removed using tongs and placed in the user's mouth, where the user's teeth are clenched and the heated mouthguard is held against the teeth by the user's lips to mold the mouthguard around the user's teeth. After the mouthguard has cooled the mouthguard shape is retained as formed around the user's teeth. If the mouthguard does not fit well the procedure is repeated.

Custom made mouthguards include taking an impression of the user's teeth, which is used by specialist manufacturers to create a best-fit mouth protector. The impression may be obtained by specifically designed home impression kit from the guard manufacturer that uses dental putty, or from a dentist who will take an upper impression in dental alginate material. This impression is generally sent to a lab where the lab ports liquid stone into the impression to make a stone model where the custom mouthguard is created and returned to the user or dentist. This traditional custom mouthguard manufacture method generally takes days. And, even if the lab, or apparatus for making the custom mouthpiece, is on-site, the impression and manufacture of the custom mouthpiece traditionally takes a minimum of a couple hours to carry out by this indirect method.

Dental bleaching, also known as tooth whitening, is a common procedure in general dentistry but most especially in the field of cosmetic dentistry. As a user ages the adult teeth often become darker due to changes in the mineral structure of the tooth, as the enamel becomes less porous. Teeth can also become stained by bacterial pigments, foodstuffs and tobacco.

There are many methods to whiten teeth: bleaching strips, bleaching pen, bleaching gel, laser bleaching, and natural bleaching. Traditionally, at-home whitening involves applying bleaching gel to the teeth using thin mouthguard trays. At-home whitening can also be done by applying small strips that go over the front teeth. Oxidizing agents such as hydrogen peroxide or carbamide peroxide are used to lighten the shade of the tooth. The oxidizing agent penetrates the porosities in the rod-like crystal structure of enamel and oxidizes interprismatic stain deposits; over a period of time, the dentin layer, lying underneath the enamel, is also bleached. Power bleaching uses light energy to accelerate the process of bleaching in a dental office.

Generally, when assisted by a dentist, a custom tooth whitening tray, or mouthpiece, is made as described above with regard to custom mouthguards using an indirect process, where an impression of the user's teeth is created, poured in stone, then and sent to a lab, or manufactured on site. The stone model of the teeth is used to melt a vacuum formed tray to the stone model. As previously discussed, such manufacture of the custom teeth whitening mouthpiece traditionally takes several hours, if not days, from the time the impression is made to the time that the custom tooth whitening mouthpiece is delivered to the user.

The subject matter claimed herein is not limited to embodiments that solve any disadvantages or that operate only in environments such as those described above. Rather, this background is only provided to illustrate one exemplary technology area where some embodiments described herein may be practiced

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an environment of wherein a method and apparatus for rapid direct manufacture of custom mouthpieces may be performed;

FIG. 1B illustrates a kit which may be used to manufacture custom direct mouthpieces in the environment of FIG. 1A;

FIGS. 2A-2B each illustrate a cross-sectional view of a form and a curing polymer which may be included in the kit of FIG. 1B;

FIG. 3A illustrates a cross-sectional view of the form and curing polymer which may be included in the kit of FIG. 1B after the kit has been used to manufacture a custom mouthpiece directly in the mouth of the user without the need to create an intermediate model of the teeth;

FIGS. 3B-3C each illustrate a bottom view and a cross-sectional side view respectively, the form defining a hole which may mechanically couple the curing polymer to the form which may be used in the environment of FIG. 1;

FIG. 4 illustrates a cross-sectional view of the curing polymer after the form has been removed from the curing polymer which may be used in the environment of FIG. 1;

FIGS. 5A-5C each illustrate side views of a relief material applied to the teeth of the user in the environment of FIG. 1, which may promote a reservoir between the teeth and the curing polymer for a whitening solution, or any treatment solution, in a teeth whitening method; and

FIG. 6 illustrates steps which may be used to manufacture the direct custom mouthpiece in the environment of FIG. 1.

### DETAILED DESCRIPTION

According to many of the teachings disclosed herein, what would be advantageous are methods and apparatus for the rapid manufacture of custom mouthpieces using a direct process as opposed to processes that use an indirect process. For example, according to several embodiments, a direct custom mouthpiece can be manufactured in a matter of minutes, instead of hours or days as was traditionally the case. To do so, as disclosed herein, a form, such as a stock or ready-made tray, including a void for holding a curing polymer is used to actively create a custom impression of the user's teeth within the curing polymer. The void can be in the form of the upper or lower jawline similar to that of a non-formed traditional boil and bite mouthguard prior to being boiled and bit. The curing polymer is different than the polymer used in the traditional boil and bite mouthpieces because rather than using heat to change the polymer's elastomeric properties, according to the teachings herein, the curing polymer is in a gel-like state when applied and undergoes a chemical curing process where the curing polymer conforms to the user's teeth during the curing process.

As discussed above, custom mouthpieces were traditionally manufactured using an indirect process by making an impression of the user's teeth which is subsequently used to create a stone model then plastic is heated to make a custom mouthpiece at a lab. Often, the impression was used to create a mold of the user's teeth which is indirectly used to create the custom mouthpiece. According to the inventor's process the custom mouthpiece is directly made. For our purposes, we refer to the direct technique being a procedure performed by the dentist chairside or by the user directly on themselves. For example, an amalgam filling is a direct procedure. The primary advantage to the direct technique is that they are performed and usually completed in one appointment or in a matter of minutes directly to the user's teeth as the mold as opposed to creating an intermediate mold thereof. Indirect techniques require impressioning the mouth and having restoration made outside of the mouth. Often two or more appointments are required where an indirect procedure is used for creating a custom mouthpiece. As disclosed herein, these indirect procedures traditionally used to make custom mouthpieces are more costly, more time and material intensive, and require the patient to make multiple appointments to obtain the custom mouthpiece.

As discovered by the inventor of this patent application, the inventive curing process for creating a custom mouthpiece also far outperforms the boil and bite process in making custom mouthpieces in that the curing polymer more closely “hugs” the teeth, and more closely conforms to the teeth, than that experienced with boil and bite mouthpieces. In addition, the inventive process no longer requires the dangerous and inconvenient act of boiling water of high heat as experience according to the prior art.

In addition, as discussed below, the inventor has discovered that using the curing polymer and form according to the teachings herein lends itself to further customizing the custom mouthpiece for the particular application and the particular user. For example, the form can be removed from the curing polymer once cured, and the curing polymer can be used as the custom mouthpiece without the form according to some embodiments. Different types of curing polymer can be used with different mechanical and chemical characteristics. And, even composite mouthpieces with multiple curing polymers and embedded materials can also be used. Additional features can be introduced into the form and/or the curing polymer to further improve the use, design, ergonomics, and/or aesthetics of the custom mouthpiece as discussed below.

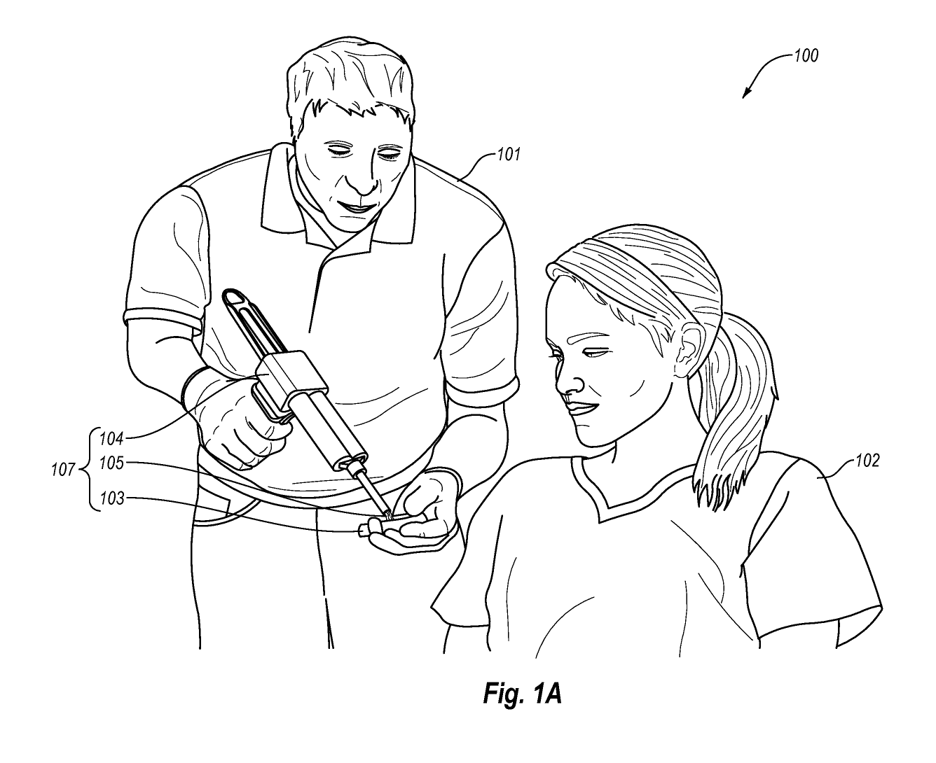

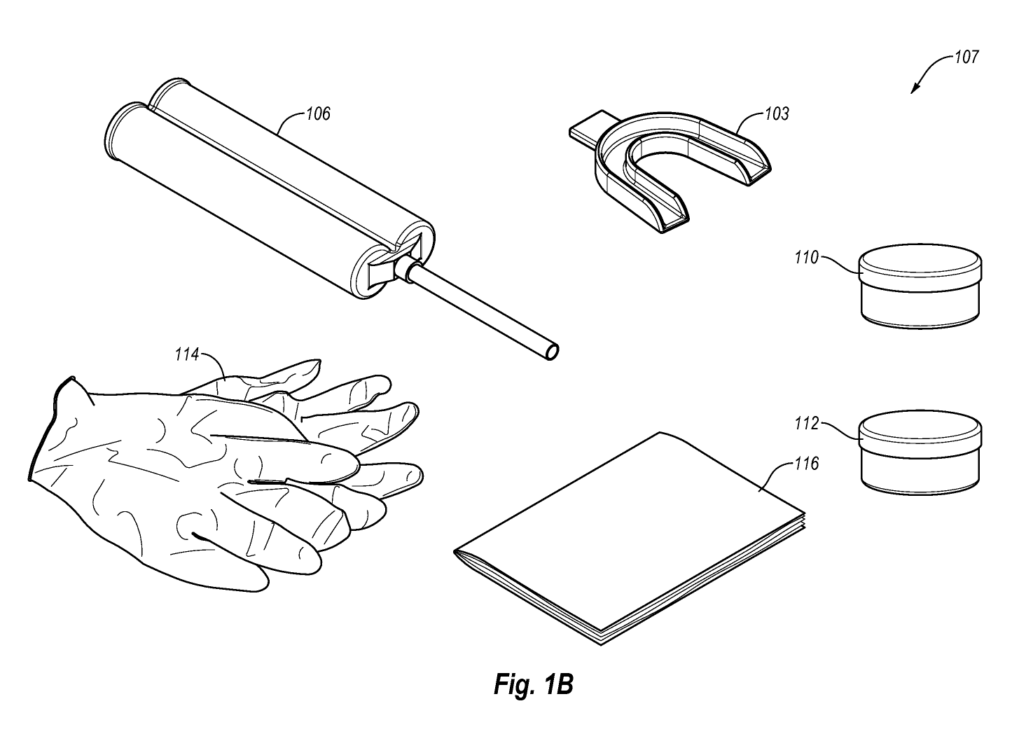

Referring to FIGS. 1-6, methods and apparatus for the rapid manufacture of a custom mouthpiece are illustrated. Referring to FIG. 1A, an environment 100 wherein the method and apparatus for rapid manufacture of custom mouthpieces is illustrated in which a dentist 101 is shown with a user 102, such as a patient or person desiring teeth whitening. In some embodiments, the dentist 101 may perform the method. However, in other embodiments any person, including the user alone, may perform method and/or use the apparatus to manufacture custom mouthpieces such as in the user's own home.

The apparatus may include a kit 107 including at least an applicator 104, a form 103, and a curing polymer 105. The dentist 101 may hold the form 103, and the applicator 104 which may be configured to hold the curing polymer 105 and may be configured to release the curing polymer 105 into the form 103. The form 103 may be a stock or ready-made mouthpiece. The form 103 can be selected, sized and/or shaped to conform generally about the user's teeth. For example, where the user 102 is relatively large, or has a relatively large jaw, the form 103 can be selected, sized, and/or shaped to conform to the user's particular jaw. For example, there can be different sizes of forms to choose from and the dentist can cut or trim the form 103 in any manner as desired.

The form 103 can also be selected, sized, and/or shaped for the particular application. For example, where the custom mouthguard is to be used as a whitening tray, the form 103 might be different than a form for a custom mouthguard for sports, biteguard, or other application.

The form 103 can be made of a cured polymer. For example, the form 103 can be formed from a rubber material, a copolymer, such as ethylene vinyl acetate, polyvinylacetate-polyethylene, or ethylene vinyl acetate (EVA) copolymer, polyvinylchloride, latex rubber, acrylic resin, polyurethane, a theremoplastic, a vinyl material, a silicone material, or any other material with the desired mechanical properties for holding the curing polymer 105 within a void of the form 103. As discussed below, when the form 103 ultimately forms part of the final custom mouthpiece, the particular material, color, transparency, and mechanical properties, as well as the shape and size, of the form 103 can be selected based on the mouthpiece's ultimate application. For example, the form 103 can have a Shore A hardness of about 70-90, a tensile strength of between about 13-27 MPa, tear strength of between 30-50 kN/m, and/or a flexural modulus of between about 9-30 MPa.

Again, the form 103 can be a common ready-made stock mouthpiece selected for the particular user and application, in this example a whitening tray/mouthpiece for a woman.

As shown in FIG. 1B the kit 107 may be a collection of the items for rapidly creating one or more custom mouthpieces according to any of the methods disclosed herein. The kit 107 can include the form 103 and the curing polymer 105. The kit 107 can include a stock or readymade mouthpiece to function as the form 103, and a tube, or applicator tube 106 of the curing polymer 105 such as the registration material discussed herein. The kit 107 can be one of several different kits made available to the dentist 101 and/or the user 102 for the different applications and different users as discussed herein. The kit 107 can also include gloves 114 for the dentist 101, or user 102 in a home application kit, to use so as not to get curing polymer 105 on their hands. The kit 107 may also provide different colors of curing polymer 105 for making different colored custom mouthpieces. The kit 107 may also include a whitening component 110, such as a tube of the whitening components disclosed herein. The kit 107 may also include relief material 112 for application to the user's teeth. The kit 107 may also include directions 116 for creating the custom mouthpiece and/or for performing a whitening procedure.

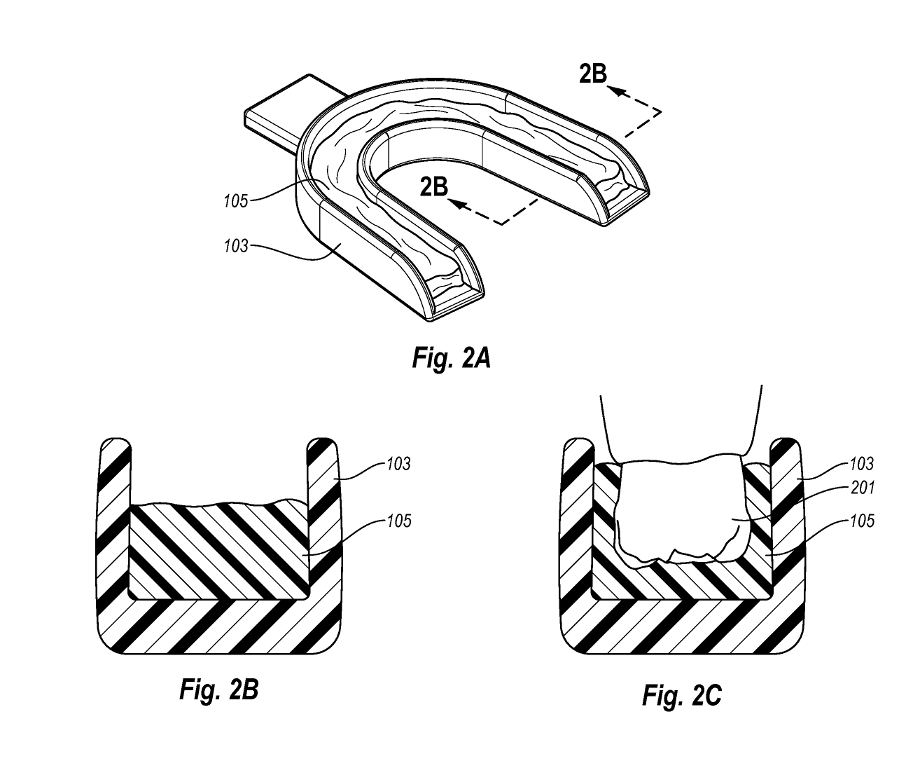

The curing polymer 105 may be applied to the form 103. The form 103 defines a void sized and configured to accommodate the teeth of the user 102. As shown in FIG. 2A the curing polymer 105 may be applied within the void of the form 103. The curing polymer 105 may be used to create the custom mouthpiece as the curing polymer 105 cures, or sets, forming a hardened polymer. As discovered by the inventor of this application, a readily available bite registration curing polymer can be selected based on its mechanical and curing properties for rapid manufacture of a custom mouthpiece, e.g. a custom whitening tray. One example of the curing polymer 105 may be a curing polymer suited for rapid curing such as a polyvinyl, or a vinyl polymer, material. Vinyl polymers are a group of polymers derived from vinyl monomers. Their backbone is an extended alkane chain, made by polymerizing an alkene group (C═C) into a chain (. . . —C—C—C—C— . . . ).

Different bite registration curing polymers have different mechanical characteristics when cured, can have different viscosities when uncured, different colors and transparencies, and different rates of chemical cure. Other characterizations of different bite registration curing polymers include consistency (CO), total working time (WT), detail reproduction (DR), linear dimensional change (LC), compatibility with gypsum (CG), recovery from deformation (RD), and strain in compression (SC) which can be determined according to ISO 4823:2000, the contents of ISO 4823:2000 are hereby incorporated by referenced herein, and tear strength (TS) and elongation at break (EL) can be determined according to DIN 53504, the contents of DIN 53504 are hereby incorporated by reference herein.

For example, bite registration curing polymers can include polyethers which are used for impression taking and include several advantageous attributes, including intrinsic hydrophilicity, unique rheology, as well as a snap setting behavior. Automatic mixing in an applicator, for example, provides exactly dosed material that is homogeneous and void free. Such polyether bight registration polymers can exhibit the characteristics in the table below and selection thereof, or a combination of attributes, for a rapidly manufactured mouthpiece can be based on one or more of the following characteristics:

| | CO | WT | LC | RD | SC | TS | EL |
|---|---|---|---|---|---|---|---|
| | [mm] | [sec] | [%] | [%] | [%] | [MPa] | [%] |
| HBQ | 33.1 (0.42)* | 141 (8)* | −0.33 (0.05) | 98.28 (0.04)* | 2.78 (0.04)* | 2.30 (0.23)* | 391 (37) |
| HB | 34.5 (0.35) | 195 (4) | −0.31 (0.03) | 98.02 (0.06) | 5.53 (0.12) | 1.88 (0.21) | 360 (53) |
| MBQ | 35.5 (0.35) | 129 (8)* | −0.38 (0.08) | 98.08 (0.08) | 2.64 (0.05)* | 2.29 (0.16)* | 330 (25) |
| MB | 35.7 (0.45) | 174 (13) | −0.33 (0.06) | 98.02 (0.07) | 5.19 (0.11) | 1.82 (0.21) | 301 (56) |
| LBQ | 41.6 (0.55) | 150 (4)* | −0.38 (0.004) | 98.83 (0.06) | 4.83 (0.12)* | 1.63 (0.07) | 224 (13) |
| LB | 41.4 (0.55) | 195 (4) | −0.40 (0.028) | 98.96 (0.07) | 5.32 (0.13) | 1.70 (0.14) | 245 (35) |

Standard ISO 4823:2000 specifies requirements and tests for evaluating dental impression curing polymers. According to the teachings disclosed herein the curing polymer 105 can have the characteristics of Type 0, 1, 2, or 3 dental impression curing polymers:

| | Consistency | | Detail reproduction | Linear | Compatibility with | | | |
|---|---|---|---|---|---|---|---|---|
| | (test disc | | (line width | dimensional | gypsum (line width | Elastic | Strain in | |
| | diameter) mm | | reproduced) | change % | reproduced) | recovery % | compression % | |
| Type | Min. | Max. | μm | Max. | μm | Min. | Min. | Max |
| O | — | 35 | 75 | 1.5 | 75 | 96.5 | 0.8 | 20 |
| 1 | — | 35 | 50 | 1.5 | 50 | 96.5 | 0.8 | 20 |
| 2 | 31 | 41 | 20 | 1.5 | 50 | 96.5 | 2.0 | 20 |
| 3 | 36 | — | 20 | 1.5 | 50 | 96.5 | 2.0 | 20 |

Physical property requirements of ISO 4823:2000

The curing polymer 105 can also have other non-specified attributes, such as Peppermint Snap™ Clear Bite Registration material made by Discus Dental, LLC of Culver city, Calif., which the Inventor of this application has found provides good characteristics for the rapid manufacture of custom mouthpieces, e.g. a custom whitening tray, when the curing polymer 105 is removed from the form 103 once the curing polymer 105 has been cured as disclosed herein. Clear curing polymer can also be advantageous where the user 102 will want to wear the mouthpiece during the day or at night and a colored mouthpiece might draw unwanted attention or have other aesthetic undesirable aspects.

The physical specifications for Peppermint Snap Clear Bite Registration may include: a clear color, a 99.6% RD, a 1.9% SC, a 63 Shore A hardness, and less than .01% of maximum dimensional change is shown below along with examples of other curing polymers that can be used for various applications to which a rapidly manufactured mouthpiece is directed according to the teachings disclosed herein.

| | | | | | Maximum |
|---|---|---|---|---|---|
| | | RD | SC | Shore A | Dimensional |
| Bite Registration Curing Polymers | Color | (%) | (%) | Hardness | Change (%) |
| Splash! & Splash! Half-Time Extra Lite | Orange | 99.7 | 4.5 | 45 | <0.1 |
| Body | | | | | |
| Splash! & Splash! Half-Time Lite Body | Green | 99.7 | 3.5 | 55 | <0.1 |
| Splash! & Splash! Half-Time Medium | Blue | 99.5 | 2.5 | 64 | <0.1 |
| Body Cartridge | | | | | |
| Splash! & Splash! Half-Time Medium | Blue | 99.5 | max 4 | 56-62 | <−.025 |
| Body FatPak | | | | | |
| Splash! & Splash! Half-Time Heavy Body | Purple | 99.2 | 2.3 | 67 | <0.1 |
| Cartridge | | | | | |
| Splash! & Splash! Half-Time Heavy Body | Purple | 99.3 | <3.5 | 57-63 | <−.025 |
| FatPak | | | | | |
| Splash! & Splash! Half-Time Putty | Purple | 99 | 2.1 | 72 | <0.1 |
| Vanilla Bite Registration | White | 99.7 | 0.7 | 90 | <0.1 |
| Peppermint Snap Clear Bite Registration | Clear | 99.6 | 1.9 | 63 | <0.1 |
| Milk Chocolate Bite Registration | Brown | 99.7 | 0.7 | 90 | <0.1 |
| MegaBite Registration | Teal | N/A | N/A | >40 | <0.20 |

| | Max working | Total Setting |
|---|---|---|
| Bite Registration Curing Polymers | Time | Time |
| Splash! & Splash! Viscosities | 2 min. 15 sec. | 4 min. 30 sec. |
| Splash! & Splash! Putty & Putty Paks | 1 min. 15 sec. | 5 min. 30 sec. |
| Splash! & Splash! Half-Time Cartridge | 1 min. 0 sec. | 2 min. 15 sec. |
| Viscosities | | |
| Splash! & Splash! Half-Time Putty & Putty | 1 min. 0 sec. | 2 min. 45 sec. |
| Paks | | |
| Vanilla Bite Registration | 20 sec. | 55 sec. |
| Peppermint Snap Clear Bite Registration | 30 sec. | 2 min. 30 sec. |
| Milk Chocolate Bite Registration | 45 sec. | 1 min. 30 sec. |
| MegaBite Registration | 20 sec. | 55 sec. |

Referring to FIG. 2A, the curing polymer 105 is applied to the void of the form 103. Referring collectively to FIGS. 2A-2C, the form 103 can have a substantially U-shaped cross section within which the curing polymer 105 may be placed. The curing polymer 105 may include two separate components that when mixed begin the curing process. Therefore, when dispensed from the applicator 104 of FIG. 1A, the working time begins and the form 103 and curing polymer 105 must be applied to the user's teeth within a relatively small period of time as compared to other conventional mouthpiece methods. Additionally or alternatively, the curing polymer 105 may be a first curing polymer and a second curing polymer may be used along with the first curing polymer to make the custom mouthpiece. For example, a first curing polymer can be applied in the form 103 with a relatively stiff cured elasticity or other material attribute as compared to a second curing polymer applied on top of the first curing polymer within the void of the form 103. In this way a non-uniform mechanical characteristic is created across a cross section of the custom mouthpiece.

In addition, different curing polymers can be applied in sections along the length of the form 103 where a first curing polymer having a first mechanical property is applied in the center near the front of the teeth as opposed to a second curing polymer having a second mechanical property different from the first mechanical property can be applied near the ends of the form where the larger teeth of the user will be molded. Such a composite mouthpiece may be advantageous where the mouthpiece is used in connection with grinding of teeth, Bruxism, or other clinching disease and the material in between the teeth typically ground must be of a stronger material than the rest of the mouthpiece which may be made of a relatively softer material for comfort.

In addition to the introduction of multiple curing polymers, other materials can be introduced into the curing polymer 105, such as strips, pieces, balls, breathing tubes for allowing air to transfer through the mouthpiece can also be introduced into the void so as to be introduced into the curing polymer 105 or into the form 103 to become part of the custom mouthpiece. The form 103 can also include small tab(s) to prevent over seating of the teeth in the curing polymer 105 to ensure thickness of the set/cured curing polymer 105 if removed from the form 103.

As shown in FIG. 2B, the form 103 and curing polymer 105 may be configured to receive one or more teeth 201 of the user 102 to make a mold of the teeth 201. The curing polymer 105 may be further configured to cure, or set, while in the mouth of the user 102. As shown in FIG. 2B, the curing polymer 105 within the void of the form 103 may be shaped to one or more of the user's 102 teeth 201, and may cure to form a mold of the teeth 201 of the user 102 after a period of setting time. The setting time may be between 30 seconds and 5 minutes. According to an advantageous embodiment the setting time may be between 1 and 3 minutes.

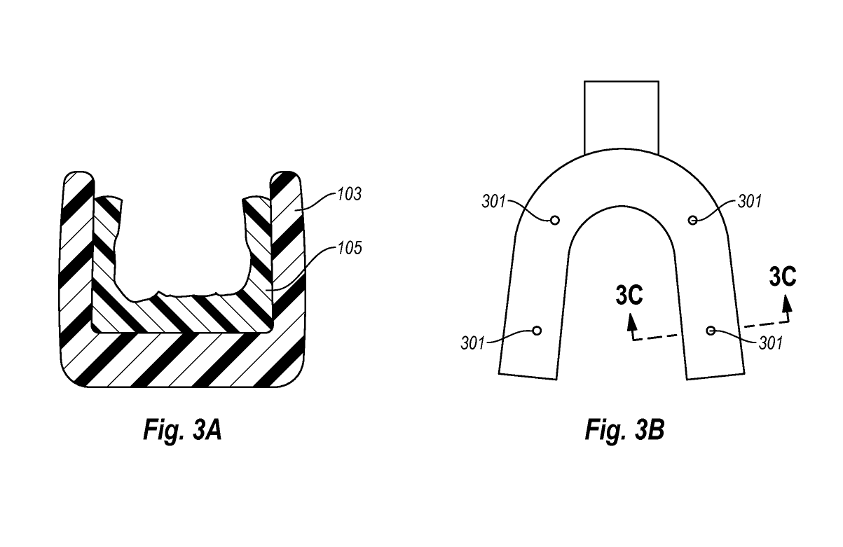

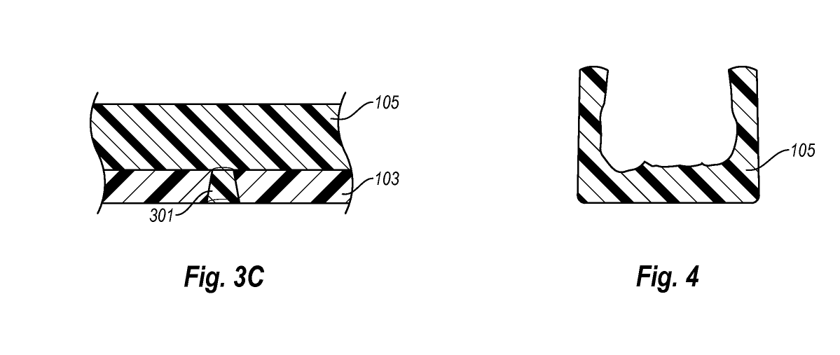

Referring to FIG. 3A, the form 103 and curing polymer 105 may be removed from the mouth of the user 102, and the set/cured curing polymer 105 may be formed in the shape of the user's 103 teeth. Preferably, the time between placement in the mouth of the user 102 and removal therefrom is less than ten minutes, more preferably less than five minutes, more preferably less than 3 minutes, and more preferably less than two minutes. The curing polymer 105 can be selected based on the curing time and other characteristics discussed above. As shown in FIG. 3A, the curing polymer 105 may remain within the form 103 where the set/cured curing polymer 105 and the form 103 may collectively act as a whitening tray, night guard, mouthguard, or mouthpiece. In these and other embodiments, when the set/cured curing polymer 105 remains within the form 103, the resulting night guard, mouthguard, or mouthpiece may be useful for TMJ, occlusal, grinding of teeth, Bruxism, or other clinching disease.

Alternatively or additionally, it may be advantageous to provide additional means to retain the curing polymer 105 within the form 103. For example, this can be more important where the mouthpiece encounters grinding associated with occlusal disease or impacts in sports.

Referring to FIGS. 3B and 3C, in these and other embodiments, the form 103 may define one or more holes 301 extending through the form 103. FIG. 3B illustrates a bottom view of the form 103 wherein the form 103 defines four holes 301 extending through the bottom of the form 103. The holes 301 can also extend through the sidewalls. As illustrated in FIG. 3B, the form 103 may define more than one hole (collectively denoted at 301), without departing from the teachings of the embodiments disclosed herein. FIG. 3C illustrates a cross-sectional side view of the form 103 and one of the holes 301 defining a non-uniform diameter through the form 103. For example, as shown the hole 301 can have a relatively larger diameter” on one end, e.g. about 4 mm, and a relatively smaller diameter on the other end, e.g. about 2 mm. Other sizes, shapes, configurations of holes can be made in order to mechanically couple the curing polymer 105 to the form 103 and prevent separation thereof. The non-uniform diameter of the hole 301 may allow a portion of the curing polymer 105 to protrude through the hole before the curing polymer 105 has set/cured. After the curing polymer 105 has set/cured, the portion of the curing polymer 105 protruding through the hole may more securely mechanically couple the curing polymer 105 to the form 103 and substantially prevent the separation of the curing polymer 105 from the form 103.

At this point the rapid manufacture of a custom mouthpiece may be completed. This mouthpiece includes both the form 103 and the set/cured curing polymer 105 that has been formed to the teeth of the user 102, and optionally also a portion of the gums of the user 102. In this example, the custom mouthpiece can now be used for whitening by placing whitening component in the mouthpiece. The whiting component can include an oxidizing agent such as hydrogen peroxide, carbamide peroxide or other whitening component.

Alternatively or additionally, it may be advantageous to create a mouthpiece with only a portion of the form 103 remaining coupled to the set/cured curing polymer 105. In these and other embodiments, the form 103 may define one or more holes 301 to mechanically couple the portion of the form 103 to the set/cured curing polymer 105. The form 103 may therefore contain a portion which is comparatively less coupled to the set/cured curing polymer 105 and may be cut away or removed. In these and other embodiments, the curing polymer 105 and the form 103 may create a mouthpiece with more material in areas predetermined to be more susceptible to grinding. For example, the user 102 may exhibit grinding patterns located near the molars, or teeth towards the back of the mouth of the user 102. The portion of the form 103 remaining coupled to the curing polymer 105 may be substantially near the molars of the user 102, providing additional material between the teeth of the user 102 in troublesome areas.

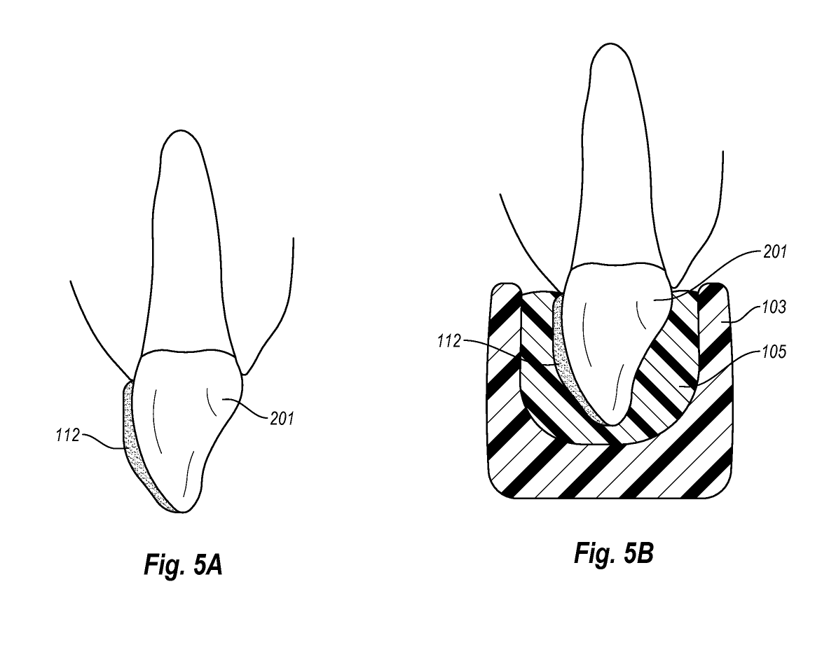

Referring to FIG. 4, the rapid manufacture of the custom mouthpiece can optionally continue with removal of the set/cured curing polymer 105 from the form 103. In these and other embodiments, the set/cured curing polymer 105 may act as a whitening tray, mouthguard, night guard, or mouthpiece by itself. As shown in FIGS. 3A and 4, the curing polymer 105 may be removed from the form 103. Removing the curing polymer 105 may be done by peeling an edge of the curing polymer 105 from the form 103 until the curing polymer 105 is entirely removed from the form 103. At this point the form 103 can be discarded, recycled, or reused, and in this embodiment the set/cured curing polymer 105 alone also constitutes a rapidly manufactured mouthpiece as shown in FIG. 8.

Accordingly, the custom mouthpiece comprising the curing polymer 105 alone may be more comfortable without the form 103 for use while sleeping or use during the day. This can be in part to different mechanical attributes of the form 103 and curing polymer 105 where the form 103 may be needed to keep the curing polymer 105 in place initially when the curing polymer 105 is in a gel-like state but not after the curing polymer 105 is set/cured. And, as previously discussed the manufacture of such custom mouthpiece can be accomplished in less than 10 minutes, preferably less than five minutes, and advantageously even less than three minutes such as short as two minutes or less.

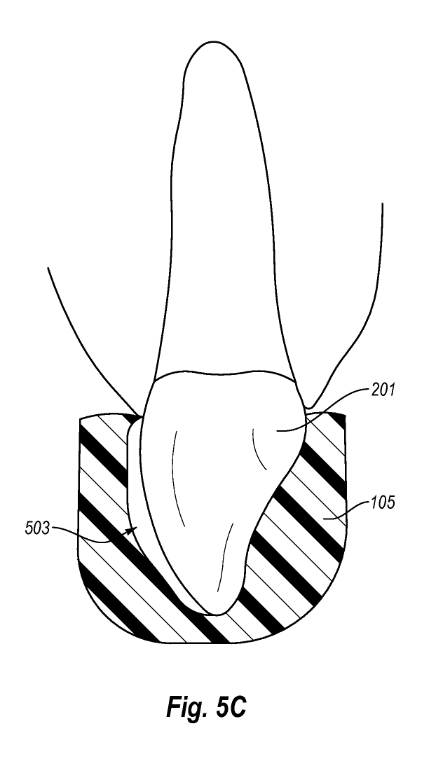

Referring to FIGS. 5A-5C, in combination with FIGS. 1-4, the kit 107 may also include relief material 112 configured to be placed on the surface of the teeth 201 before the curing polymer 105 receives the teeth 201. As shown in FIG. 5A, the relief material 112 may be placed directly on the teeth 201 of the user 102. The relief material 112 may be composed of a plastic, acrylic, polymer, wax, or other material applied to the user's 102 teeth 201 in locations where whitening component, gel or other material, would preferably be kept during the use of the custom mouthpiece, such as during whitening treatment. So, for example, in FIG. 5A the relief material 112, in this instance a plastic, is applied to the user's 102 teeth 201. In some embodiments, light can optionally be used to speed the adherence and/or curing of the relief material 112 to the user's teeth 201. Once the relief material 112 has been placed on the teeth 201 of the user 102, the form 103 and the curing polymer 105 may be placed inside the mouth of the user 102, wherein the curing polymer 105 may receive the teeth as shown in FIG. 3B. In other words, the process for manufacturing a custom mouthpiece continues as in FIG. 1A-5C, and as discussed above. After the mouthpiece is manufactured and removed from the user's 102 mouth the relief material 112 can be removed from the user's 102 teeth 201. The relief material 112 may be configured to create the reservoir 503 after the curing polymer 105 has set/cured as shown in FIG. 3C. The reservoir 503 may be configured to receive a whitening component 110. Therefore, when whitening component 110 is applied to the custom mouthpiece the whitening component 110 has some desired level of relief in the custom mouthpiece for the bleaching treatment. The set/cured curing polymer 105 may also be trimmed by a scissors or other instrument.

For example, if the user 102 desires to create a custom mouthpiece designed to hold the whitening component 110, the relief material 112 may first be applied to the teeth 201 of the user 102 to create a space between the curing polymer 105 and the teeth 201. Once the curing polymer 105 has set/cured, the set/cured curing polymer 105 may define the reservoir 503 configured to hold a whitening component 110, and allowing the user 102 to apply whitening component 110 to the teeth 201.

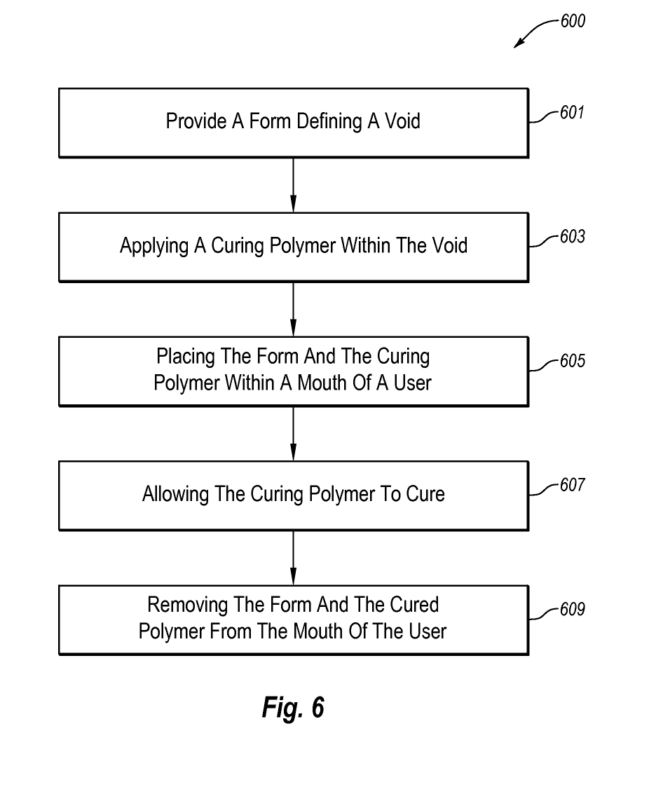

The kit 107 may be used in a method for the rapid manufacture of a custom mouthpiece, e.g. custom whitening mouthpiece. FIG. 6 illustrates a method 600 for rapid manufacture of a custom mouthpiece.

The method 600 may begin at block 601 in which a form defining a void is provided. The method 600 may continue at block 603 in which a curing polymer is applied within the void of the form. The form and the curing polymer may be similar to the form 103 and the curing polymer 105 discussed above with reference to FIGS. 1-5C.

The method 600 may continue at block 605 in which the form and the curing polymer are placed within the mouth of a user. The form and the curing polymer may be placed within the mouth of the user so as to move the teeth of the user into the curing polymer to make a mold of the teeth of the user.

The method 600 may continue at block 607 in which the curing polymer is allowed to cure. The curing polymer may be allowed to set for a setting time between thirty seconds and five minutes. According to an advantageous embodiment the setting time may be between 1 and 3 minutes.

The method 600 may continue at block 609 in which the form and the curing polymer are removed from the mouth of the user. The cured polymer may represent at least a part of the custom mouthpiece for later use by the user. The method 600 may comprise additional steps without departing from the embodiments of the method 600 as described herein. For instance, the method 600 may further comprise leaving the curing polymer within the form. The form and the cured polymer may collectively act as a whitening tray night guard, mouthguard, or mouthpiece. The form and cured polymer may be a custom mouthpiece and may be a custom night guard for TMJ, occlusal, grinding of teeth, Bruxism, and/or clinching disease.

It may be advantageous to couple the curing polymer to the form to prevent separation of the curing polymer from the form. In these and other embodiments, the form may define a hole extending through the form. The hole may have a non-uniform diameter through the form. The hole may therefore be configured to mechanically couple the curing polymer to the form and substantially prevent separation thereof.

Alternatively or additionally, the method 600 may further include removing the form from the cured polymer in which the cured polymer acts as a whitening tray, mouthguard, night guard, or mouthpiece by itself. In these and other embodiments, the curing polymer, once set or cured, may by itself provide a more comfortable mouthguard, night guard, or mouthpiece without the additional material of the form.

Alternatively or additionally, the curing polymer may be comprised of more than one type of curing polymer. For example, a first curing polymer can be applied in the form 103 with a relatively stiff cured elasticity or other material attribute as compared to a second curing polymer applied on top of the first curing polymer within the void of the form. In this way a non-uniform mechanical characteristic is created across a cross section of the custom mouthpiece.

Alternatively or additionally, the method 600 may further comprise applying a relief material to the teeth of the user prior to placing the form and the curing polymer within the mouth of the user to promote a reservoir for an active whitening component for use within the curing polymer after the curing polymer has cured. The reservoir may provide the user with a custom mouthpiece which is useful as a whitening tray being specifically fitted to the user's teeth, while providing enough room for the active whitening component to be applied to the user's teeth. The relief material can be a plastic, acrylic, polymer, wax, or other material applied to the user's teeth in locations where whitening component, gel or other material, would like to be kept during the use of the custom mouthpiece, such as during whitening treatment.

In each instance, according to the methods and apparatus disclosed herein, a similar, or the same, method can be performed for both the upper and lower teeth to form a custom mouthpiece for each set of teeth. This can be carried out either in series or at the same time using multiple forms and application of curing polymer. Moreover, a double form can be created with opposing voids for simultaneously creating custom mouthpieces for the upper and lower teeth of a user's mouth, where the double form can be removed from both formed curable polymers or the double form can be retained.

Additional manufacturing steps can be performed to further refine, tailor, or improve the mouthpiece, but as shown in FIG. 6, at this point the mouthpiece, “custom whitening tray”, can be used for whitening or other uses discussed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A direct method for rapidly creating a custom mouthpiece, comprising:
providing a form defining a void sized and configured to accommodate teeth of a user;
applying a curing polymer within the void;
placing the form and the curing polymer within a mouth of the user so as to move the teeth of the user into the curing polymer to make a mold of the teeth of the user;
allowing the curing polymer to cure while in the mouth of the user; and
removing the form and curing polymer from the mouth of the user where the cured polymer represents at least part of the custom mouthpiece for later use by the user.

2. The direct method according to claim 1, further comprising leaving the curing polymer within the form where the cured polymer and the form collectively act as a whitening tray night guard, mouthguard, or mouthpiece.

3. The direct method according to claim 2, wherein:
the form defines a hole extending through the form;
the hole having a non-uniform diameter through the form; and
the hole is configured to mechanically couple the curing polymer to the form and substantially prevent separation of thereof.

4. The direct method according to claim 1 further comprising removing the form from the cured polymer in which the cured polymer acts as a whitening tray, mouthguard, night guard, or mouthpiece by itself.

5. The direct method according to claim 1, further comprising first applying a relief material directly to the teeth of the user prior to placing the form and curing polymer within the mouth of the user to promote a reservoir for an active whitening component for use within the curing polymer after the curing polymer has cured.

6. The direct method according to claim 1, further comprising selecting the curing polymer and/or form based on a characteristic of the material of the curing polymer and/or form or on a characteristic of the user or of the application of the mouthpiece, such as a custom whitening tray application.

7. The direct method according to claim 1, wherein the custom mouthpiece is a custom night guard for TMJ, occlusal, grinding of teeth, Bruxism, and/or clinching disease.

8. The direct method according to claim 1, wherein the curing polymer comprises more than one type of curing polymer having a different mechanical properties.

9. A kit for rapidly creating a direct custom mouthpiece comprising:
a form defining a void sized and configured to accommodate teeth of a user; and
a curing polymer configured to:
be placed within the void of the form,
receive teeth of a user to make a mold of the teeth, and
cure forming a hardened polymer representing at least part of the custom mouthpiece.

10. The kit according to claim 9, further comprising a relief material configured to:
be placed directly on the surface of the teeth before the curing polymer receives the teeth, and
create a reservoir in the custom mouthpeice after the curing polymer has cured, wherein the reservoir is configured to receive and retain a whitening component against the teeth at a location of desired whitening.

11. The kit according to claim 9, wherein the kit is configured to create a custom night guard for one or more of: TMJ, occlusal, grinding of teeth, Bruxism, or other clinching disease.

12. The kit according to claim 9, wherein the cured polymer remains within the form where the cured polymer and the form collectively act as a whitening tray night guard, mouthguard, or mouthpiece.

13. The kit according to claim 9, wherein:
the form defines a hole extending through the form;
the hole defining a non-uniform diameter through the form; and
the hole is configured to mechanically couple the curing polymer to the form and substantially prevent separation of thereof.

14. The kit according to claim 13, wherein only a portion of the form is mechanically coupled to the curing polymer, and wherein other portions of the form is removed from the curing polymer.

15. The kit according to claim 9, wherein the cured polymer is removed from the form, and wherein the cured polymer acts as a whitening tray, mouthguard, night guard, or mouthpiece by itself.

16. The kit according to claim 9, wherein the form further comprises tabs configured to substantially ensure thickness of the cured polymer.

17. The kit according to claim 9, further comprising:
a pair of gloves configured to substantially prevent spillage of the curing polymer onto skin of a user;
an applicator tube configured to hold the curing polymer and configured to release the curing polymer into the form;
a whitening component;
relief material configured to create reservoir within the curing polymer for placing the whitening component;
directions for creating a custom mouthpiece; or
directions for performing a teeth whitening procedure.

18. The kit according to claim 9, wherein the curing polymer is a first curing polymer, further comprising a second curing polymer configured to be used along with the first curing polymer to make the custom mouthpiece the first and second curing polymers having different mechanical attributes when cured.

19. The kit according to claim 9, wherein the curing polymer is cured in a setting time between thirty seconds and five minutes.

20. The kit according to claim 9, wherein the curing polymer is cured in a setting time of less than three minutes.
